(19) United States
(12) Patent Application Publication
(10) Pub. No.: US 2007/0201711 A1
(43) Pub. Date: Aug. 30, 2007

(54) Loudspeaker system and method for producing a controllable synthesized sound field

(76) Inventors: John D. Meyer, Berkeley, CA (US); Perrin Meyer, Albany, CA (US); Roger Schwenke, Albany, CA (US); Alejandro Antonio Garcia Rubio, Berkeley, CA (US)

Correspondence Address: BEESON SKINNER BEVERLY, LLP, ONE KAISER PLAZA, SUITE 750, OAKLAND, CA, 94612, US

(21) Appl. No.: 11/641,549

(22) Filed: Dec. 18, 2006

Related U.S. Application Data
(60) Provisional application No. 60/751,006, filed on Dec. 16, 2005.

(51) Int. Cl. H04R 25/00; H04R 1/02; H04R 9/06

(52) U.S. Cl. 381/182; 381/335; 381/186

(57) ABSTRACT

A loudspeaker system has of a plurality of relatively small, closely spaced transducer elements, the acoustic outputs of which combine to create a sound field. The transducer elements are individually controlled by a distributed input control circuit, which includes digital signal processing, to synthesize a sound field in front of the transducer elements with a characteristic beam width and direction.

### CROSS-REFERENCE TO RELATED APPLICATIONS

This application claims the benefit of U.S. Provisional application No. 60/751,006 filed Dec. 16, 2005.

### BACKGROUND OF THE INVENTION

The present invention generally relates to loudspeakers used for sound reinforcement, and more particularly relates to loudspeakers capable of focusing a large amount of acoustic energy into a relatively narrow beam of intelligible sound that can be propagated over long distances.

Long throw acoustical transmitting systems have been devised using parabolic dishes to focus the acoustic energy produced by a driving transducer positioned at the focal point of the parabolic dish. One such loudspeaker system in described in U.S. Pat. No. 5,821,470. This patent describes a system in which a parabolic dish reflects acoustic power produced by a high frequency horn loaded driver, and in which a low frequency driver is embedded in the center of the dish for extending the low end of the system's frequency range. Parabolic dish systems such as disclosed in U.S. Pat. No. 5,821,470 are capable of producing a relatively narrow beam of high acoustic power for long throw applications. However, they have a number of disadvantages.

First, the parabolic dishes and the mechanical structures required to support a driver at the dishes focal point create a relatively large and bulky apparatus. Consequently, this type of system is not well suited to applications where space is limited. Also, the dishes must physically be moved in order to re-direct the beam of acoustic energy produced by the system. This limits the user's ability to easily change the target area for the narrowly focused acoustic energy. Still further, parabolic dish systems have fixed beam width characteristics, and thus there is no ability to adjust the coverage of the system. The beam width at low frequencies is also normally larger than it is at high frequencies, creating perimeter zones at the target area where hi fidelity sound is not heard.

The present invention overcomes the drawbacks of existing long throw parabolic dish systems by providing an improved loudspeaker system that is relatively compact and that produces a beam of acoustic energy capable of being steered without having to physically move the loudspeaker. The present invention also provides an improved loudspeaker system and method that produces a beam of acoustic energy, the width and shape of which is capable of being adjusted. The long throw loudspeaker system of the invention also is capable of producing a beam of acoustic energy where the beam width is relatively constant over the frequency range of the system.

### SUMMARY OF THE INVENTION

The loudspeaker system of the invention is comprised of a plurality of closely spaced transducer elements, the acoustic outputs of which combine to create a sound field. The transducer elements are individually controlled by a distributed input control circuit to synthesize a sound field in front of the transducer elements, which has a characteristic beam width and direction as exhibited by its polar pattern. The behavior of this polar pattern can be controlled: it can be altered from a wide flood pattern to a narrow focused beam (or made to produce more than one beam), and its angle can be changed in real-time. In the case of a narrow beam of acoustic energy, real-time angle changes can make the beam behave like a scanning spotlight. Side lobes are also substantially eliminated. This is a particular advantage in high power applications where people may be located close to the side of the loudspeaker. At very high sound pressure levels (SPL), side lobes could interfere with the operators of the loudspeaker.

The individual transducer elements of the loudspeaker system are relatively small, preferably matched elements, arranged in a plane. The plane is preferably flat, however, it is contemplated that sound field synthesis in accordance with the invention could be achieved with transducer elements lying in a plane having some degree of curvature. Preferably, the transducer elements are relatively evenly distributed within this plane, without substantial variations in their center-to-center spacings. To achieve a close and relatively uniform spacings, the transducer elements are preferably arranged in concentric rings of decreasing diameters with a decreasing number of elements in each ring from the perimeter ring to the center-most ring.

Most suitably the transducer elements have a diameter in the range of one to two inches and center-to-center spacings of about one to two inches between adjacent elements, however deviations from this range are possible. The diaphragm excursion for each transducer element should be suitably large to achieve desired sound pressure levels.

In another aspect of the invention, the individual transducer elements are mounted to a rigid mounting plate structure, suitably a flat circular structure, having a heat sink for dissipating heat generated by each of the transducer elements. The mounting plate structure is preferably comprised of an aluminum base plate and a plastic intermediate mounting plate glued to the base plate. The intermediate mounting plate is provided with an array of mounting holes which are sized to receive the transducer elements and which are closely spaced and distributed to fix the element's desired spacing and distribution. In addition to fixing the transducer elements in their desired spacing and distribution in a rigid plane, the mounting plate structure baffles the transducer elements to prevent undesirable rear lobes.

The method of the invention is a method of producing a synthesized sound field, the characteristics of which can be altered electronically through signal processing. The method is comprised of providing a plurality of relatively small, closely spaced transducer elements in a rigid plane in a distribution that is preferably relatively even or uniform. Each of the provided transducer elements is separately driven by a separately controlled signal input from a distributed input control circuit to produce acoustic outputs which combine to create a desire synthesized sound field. The signal input to each element is preferably produced from a separate amplifier and from a signal processing circuit capable of controlling the amplitude and phase of each signal input.

The loudspeaker system and method of the invention has particular application as a long throw loudspeaker wherein the sound field produced by the closely packed transducer elements produce a synthesized sound field in the form of a narrow steerable beam. Because the system and method provides for a beam of acoustic energy with no side lobes or rear lobes, the loudspeaker system is capable of directing all of its acoustic power into the intended beam. This also allows an operator to stand behind the loudspeaker and use a microphone without feedback.

It will be appreciated the loudspeaker system and method of the invention is not limited to long throw applications, but could be used in any application where control, and particularly dynamic control over the system's polar pattern is desired.

### BRIEF DESCRIPTION OF DRAWINGS

FIG. 1 of the drawings is a graphical representation of a loudspeaker system in accordance with the invention showing and plurality of closely spaced transducer elements in a plane and a distributed input control circuit for individually controlling each transducer element.

FIG. 2 is a top perspective, cross-sectional view of the closely spaced transducer elements mounted to a mounting plate structure for fixing the elements in a closely spaced arrangement in a plane.

### DESCRIPTION OF THE ILLUSTRATED EMBODIMENT

The sound field synthesis loudspeaker system of the invention can produce sound fields that exhibit controlled behavior. This behavior is dependent on the size and placement of the transducer elements and can be predicted based on the mathematics of linear wave equations. The Kirchhoff-Helmholtz integral theorem provides the mathematical framework for determining the placement of the transducer elements and boundary conditions to create different sound field characteristics.

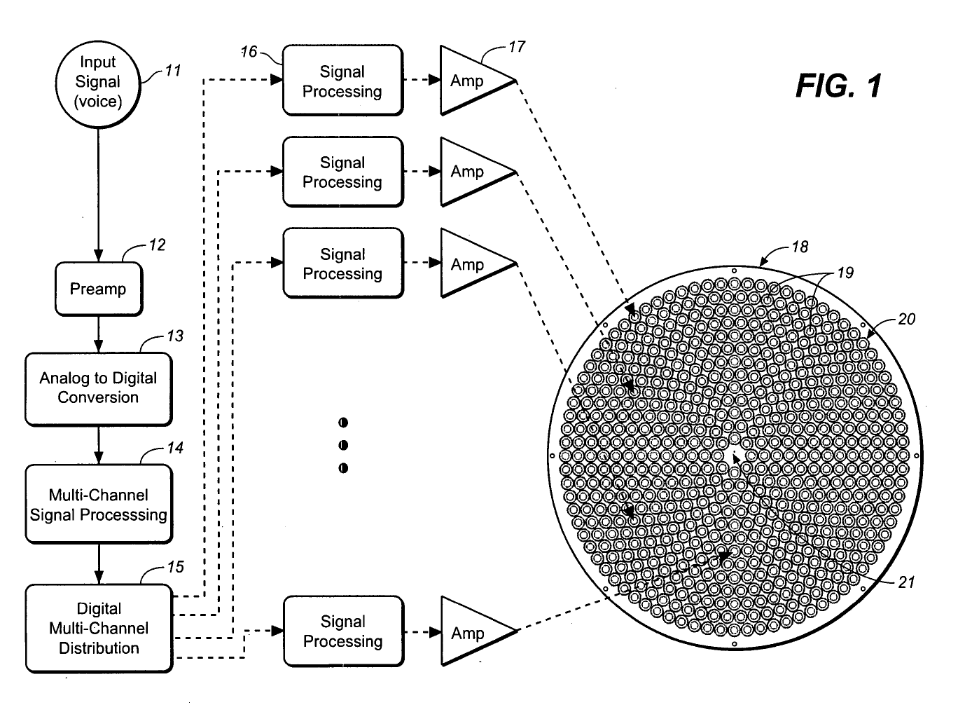

Referring now to FIG. 1, the illustrated loudspeaker system receives a signal input from an input source 11, which can be a voice signal from a microphone (such as a standard pro audio XLR microphone), pre-recorded tape or the like. The signal input is fed to a preamplifier 12, which provides gain for direct microphone feed or balanced or unbalanced line input for a tape feed. The output from the pre-amplifier then goes through an analog-to-digital conversion as represented by the A/D conversion block 13. A multi-channel digital signal processor 14 takes the single input source and creates an independently filtered digital output signal for each transducer element of the system. These separate digital outputs are used to control the polar pattern of the sound field produced by the transducer elements. Specifically, the multi-channel signal processing is used to alter the magnitude and phase of the signal for each transducer on a per frequency basis to provide control of the resultant beam on a per frequency basis.

As denoted by block 15, a multi-channel digital distribution network is provided to distribute the multi-channel digital outputs from the multi-channel signal processor 14 to separate distributed signal paths, each of which has a separate signal processor 16 and power amplifier 17. The additional distributed signal processing provided by digital signal processors 16 introduces driver protection using compressing and power limiting, and additional transducer equalization that may be needed to normalize manufacturing tolerances in the transducers.

The digital signals outputted form the digital signal processors 16 are converted to analog signals at the amplifier stage of the distributed signal paths. The separate power amplifiers are preferably high power high amplifiers that provide high peak-to-average power to process large dynamic range signals such as voice signals. It is contemplated that each transducer element of the transducer array 18 could be mounted directly on each amplifier. To accomplish this each amplifier must have low heat dissipation to allow for dense spacing.

The transducer element array 18 is comprised of individual, relatively small transducer elements 19, preferably in the form of dome tweeters and preferably capable of peak-to-peak diaphragm (dome) excursions of 4 mm or more in order to produce suitable sound pressure levels. Preferably, the transducer elements will be matched transducer elements of the same size, and most suitably they will have an overall circular physical shape with an outside diameter in the range of about one to two inches and nominal center-to-center spacings of about one to two inches, however, deviations from these ranges are possible. It is contemplated transducer sizes in the range of two and one-half and three inches with a nominal center-to-center spacing of two and one-half to three inches would constitute the upper limit of a usable system in accordance with the invention.

The transducer elements 19 are seen to be packed together in a close spacing in a manner that creates a density of elements that is substantially uniform from the array's outer perimeter 20 to its center 21. Preferably, the center-to-center spacing between adjacent transducer elements will vary less than 10% throughout the array, however, transducer element arrays having larger center-to-center variations are possible and considered within the scope of the invention. As variations in the center-to-center spacings increase, the variations may have to be compensated for by signal processing.

To achieve relatively uniform packing of the array of transducer elements, the transducer elements are suitably placed in concentric rings with the number of elements in each ring decreasing as you progress toward the array's center. The resulting close spacing eliminates side lobes and allows for beam spreading and steering. The uniform density allows uniform sound field and coverage and eliminates side lobes and stray beams. Other close packing arrangements may be possible, such as a packing arrangement that results in a rectangular array of transducer elements.

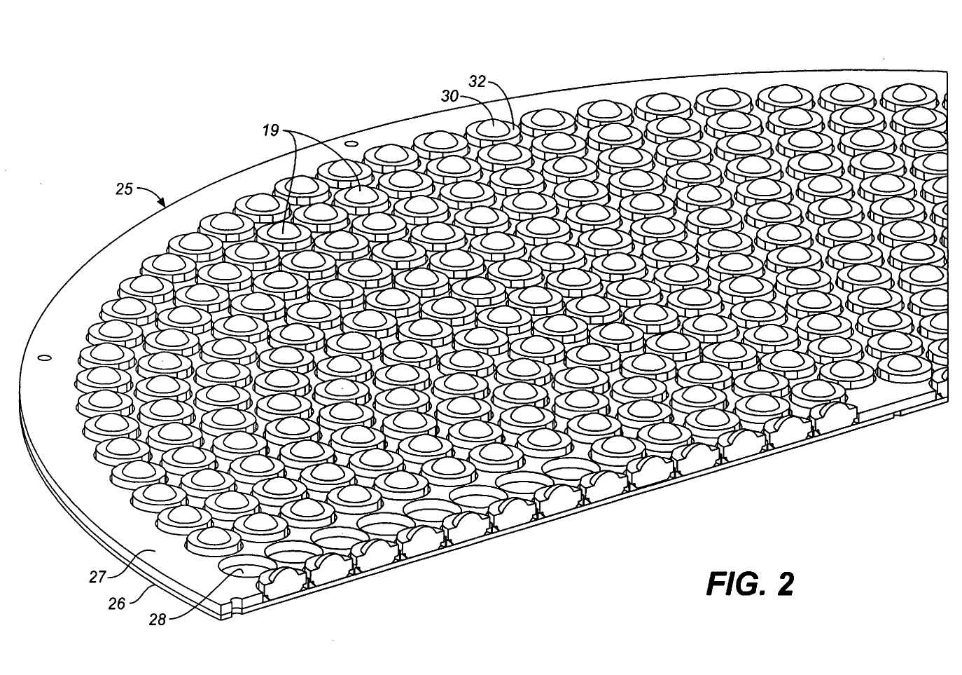

FIG. 2 shows the transducer elements 19 mounted to a flat mounting plate structure 25 comprised of a circular aluminum base plate 26, which is heat conductive, and a circular intermediate mounting plate 27 suitably fabricated of plastic. The plastic mounting plate 27 is provided with closely spaced mounting holes 28 sized to receive and fix the location of the individual transducer elements. The mounting plate and base plate are suitably glued together by a commercialy available glue, such as Sikaflex 221. The transducer elements are preferably attached directly to the base plate 26 so that the base plate acts as a heat sink for the transducers. This attachment can be achieved by gluing the back of the transducer, which is metal, to the base plate using a commercially available thermally conductive glue, such as Loctite 383.

The small transducer elements are most suitably provided in the form of small dome tweeters having a dome diaphragm 30 and a diaphragm assembly frame 32, which surrounds the diaphragm and the transducer's magnetic assembly (not shown), and which defines the overall physical shape and dimensions of the transducer element. Small dome tweeters that produce high power and that have physical dimensions in the range of one to two inches in diameter are commercially available. It is noted that use of transducer elements having other physical shapes may be possible, such as a transducer having a square diaphragm assembly frame.

A loudspeaker system in accordance with the invention having an upper frequency limit of 6 KHz can be achieved with two inch diameter dome tweeters having a nominal center-to-center spacing two inches. Approximately 256 to 270 high-power matched dome tweeters, each having a 32 mm diameter dome with a four millimeter excursion, can be packed in concentric rings onto a one meter circular mounting plate structure with substantially uniform density, that is, with substantially uniform spacings between transducers. Such packing has been achieved with center-to-center spacings between transducers of between 2.05 inches and 2.15 inches. Such a system would be capable of producing focused narrow lobe of acoustic power at relatively high sound pressure levels.

In order to reach a 12 KHz bandwidth, the transducer elements would have to have a nominal center-to-center spacing of one inch, which would call for a smaller dimensioned transducer element of about one inch. However, the smaller transducer elements of such a system would have smaller diaphragms and voice coils, and thus less power handling capability.

As an example of a loudspeaker system in accordance with the invention using smaller transducer elements and having a higher upper frequency limit, 440 customized Ciare dome tweeters having an overall physical diameter of 1.3 inches, and 23 mm domes were packed in concentric rings onto a one meter diameter circular mounting plate with center-to-center spacings ranging from 1.5 to 2.12 inches and with an average spacing of approximately 1.75 inches. With each tweeter being driven at 4 watts, 141 db continuous power and 153 db peak power at one meter over the frequency range of the system was measured.

While the invention has been described in considerable detail in the foregoing specification, it shall be understood that it is not intended that the invention be limited to such detail, except as necessitated by the following claims.

What we claim is:

1. A loudspeaker system for producing a controllable synthesized sound field comprising
a plurality of relatively small transducer elements, said transducer elements being arranged in a closely spaced relationship in a plane forming a closely packed transducer array, and
the transducer elements of said transducer array having a center-to-center spacing that is relatively uniform throughout said array,
wherein each of said transducer elements can be separately driven by a separately controlled signal input from a distributed input control circuit to produce acoustic outputs which combine to create a desire synthesized sound field.

2. The loudspeaker system of claim 1 wherein said transducer elements are matched transducers.

3. The loudspeaker system of claim 1 wherein each of said transducer elements has a generally circular geometry with substantially the same diameter, and wherein the diameter of each of said transducer elements is between about one and two inches.

4. The loudspeaker system of claim 1 wherein the spacing between said transducer elements varies by less the about ten percent throughout the array of transducer elements.

5. The loudspeaker system of claim 1 wherein the array of transducer elements has a center, and wherein said transducer elements are arranged in concentric rings with the number of transducer elements in each ring decreasing toward the center of said array for achieving a close spacing between transducer elements.

6. The loudspeaker system of claim 1 wherein the center-to-center spacing between said transducer elements is between about one and two inches.

7. The loudspeaker system of claim 1 wherein said transducer elements are arranged in a flat plane.

8. The loudspeaker system of claim 1 further comprising a rigid mounting plate structure and wherein said transducer elements are mounted in a closely spaced relationship to said mounting plate structure.

9. The loudspeaker system of claim 8 wherein said mounting plate structure includes a heat conductive base plate, and wherein said transducer elements are in thermal contact with said base plate.

10. The loudspeaker system of claim 9 wherein said mounting plate structure further includes a planar mounting plate affixed to base plate, said mounting plate having a plurality of closely spaced mounting holes for receiving and fixing the location of said plurality of transducer elements in a plane and in thermal contact with said thermally conducting base plate.

11. The loudspeaker system of claim 10 wherein said mounting plate is fabricated of a rigid plastic material.

12. The loudspeaker system of claim 1 wherein said transducer elements include a diaphragm for producing acoustic power, and wherein each of said transducer elements is capable of producing peak-to-peak diaphragm excursions of at least about 4 mm.

13. The loudspeaker system of claim 1 wherein said transducer elements are dome tweeters.

14. A loudspeaker system for producing a controllable synthesized sound field comprising
a mounting plate structure, said mounting plate including a heat conductive base plate, and
a plurality of generally circular acoustical transducer elements mounted in closely packed concentric circles to said mounting plate structure to form an array of closely packed transducer elements thereon having center-to-center spacings that are relatively uniform throughout said array, said transducer elements being in thermal contact with said heat conductive base plate,
wherein each of said transducer elements can be separately driven by a separately controlled signal input from a distributed input control circuit to produce acoustic outputs which combine to create a desire synthesized sound field.

15. The loudspeaker system of claim 14 wherein the center-to-center spacing between said transducer elements is between about one and two inches.

16. The loudspeaker system of claim 14 wherein the diameter of each of said transducer elements is between about one and two inches.

17. The loudspeaker system of claim 14 wherein the transducer elements have an overall circular shape and a diameter of about two inches and wherein the center-to-center spacing between transducer elements is close two inches throughout said array.

18. A method of producing roducing a synthesized sound field, the characteristics of which can be altered electronically through signal processing, comprising
providing a plurality of relatively small, closely spaced transducer elements in a plane in a relatively uniform distribution,
separately driving each of said transducer elements by a separately controlled signal input from a distributed input control circuit to produce acoustic outputs which combine to create a desire synthesized sound field.

19. The method of claim 18 wherein each of said transducer elements is separately driven from a multi-channel digital signal processor providing separate distributed signal paths for each transducer.

20. The method of claim 19 wherein each each of said signal paths has a separate digital signal processor and a separate power amplifier.
